(19) United States
(12) Patent Application Publication
(10) Pub. No.: US 2005/0153048 A1
(43) Pub. Date: Jul. 14, 2005

(54) Butter dish

(76) Inventor: Jules Arnold Weisfeld, Seattle, WA (US)

Correspondence Address: LAW OFFICE OF POLLY L. OLIVER, P.O. BOX 4625, FEDERAL WAY, WA, 98063, US

(21) Appl. No.: 11/056,909

(22) Filed: Feb. 11, 2005

Related U.S. Application Data
(63) Continuation of application No. 10/372,918, filed on Feb. 24, 2003.

(51) Int. Cl. A23L 1/05

(52) U.S. Cl. 426/578

(57) ABSTRACT

A novel inclined butter dish comprising a tray and two endpieces. The tray is attached between the endpieces such that it is longitudinally inclined from the horizontal with one end higher than the other, so that the stick of butter rests against the lower endpiece, thereby facilitating the shaving or cutting of a pat from the high end of the stick of butter. The lower endpiece is large enough to provide a stop for the butter stick and absorb any normal force from the butter knife while the pat is being cut from the upper end. The tray is also angled from the horizontal in the lateral direction so that the stick of butter will be contained within the butter dish and will not slide thereon, as is common with traditional butter dishes.

### RELATED APPLICATION

This application is a continuation of regular application Ser. No. 10/372,918, filed Feb. 24, 2003.

### FIELD OF THE INVENTION

This invention pertains generally to kitchen equipment and more specifically to a new design for an inclined butter dish.

### BACKGROUND OF THE FIELD

Traditionally, butter is provided in sticks, usually four sticks to a pound of butter, and many people prefer to have butter sticks available on the table during a meal. They usually place the stick of butter on a butter dish with a butter knife available. Most butter dishes are flat plates, often rectangular in shape. Frequently, when a person tries to cut a pat of butter from one end of the stick with the butter knife, the stick slides around the plate. Also, the butter may melt while at room temperature for extended periods of time, and the excess liquid butter runs off the plate onto the tabletop.

Prior patents have addressed some of these problems with varying successes. For instance, U.S. Pat. No. D297,200 to DeVito discloses a butter tray with a single endplate that is intended to act as a stop for the butter stick. DeVito's design also has a tab on the base plate that presses into the stick to help prevent longitudinal sliding, but DeVito's design does not stop the butter stick from sliding laterally.

In another case, U.S. Pat. No. 6,352,01 3 to Schlattl also discloses a butter dish with an endplate. But once again, Schlattl's device does not prevent lateral sliding of the butter stick. Schlattl's device additionally includes means for slicing pats from the butter with a cutting blade integral to the hinged cover. However, Schlattl's hinged cover introduces undue complexity into the device, making it difficult to clean and maintain.

### SUMMARY

The present invention solves the above-mentioned problems by providing a new butter dish for a stick of butter (typically a parallelopiped having a generally square cross-section) that contains the butter and any liquid runoff in a tray. The generally rectangular tray is angled along its length to match the stick of butter, i.e., slightly greater than ninety degrees, and the butter dish has two endpieces that act as stops for the stick of butter. The tray is inclined between the two endpieces such that one end of the tray is lower than the other, and the butter stick will rest against the corresponding endpiece.

The invention enables the user to cut off a pat of butter from the upper end of the stick without the butter stick sliding in any direction on or off the butter dish or making a mess on the tabletop. Using the new butter dish, a person can easily access all of the butter in the stick in a controlled fashion, as well as any liquid butter in the tray. By differently configuring the tray and endpieces, the butter dish can be made specifically for left-handed or right-handed users.

### BRIEF DESCRIPTION OF THE DRAWINGS

FIG. 1 is a perspective view of the preferred embodiment of the butter dish; and

FIG. 2 is a front elevational view of the preferred embodiment.

### DETAILED DESCRIPTION

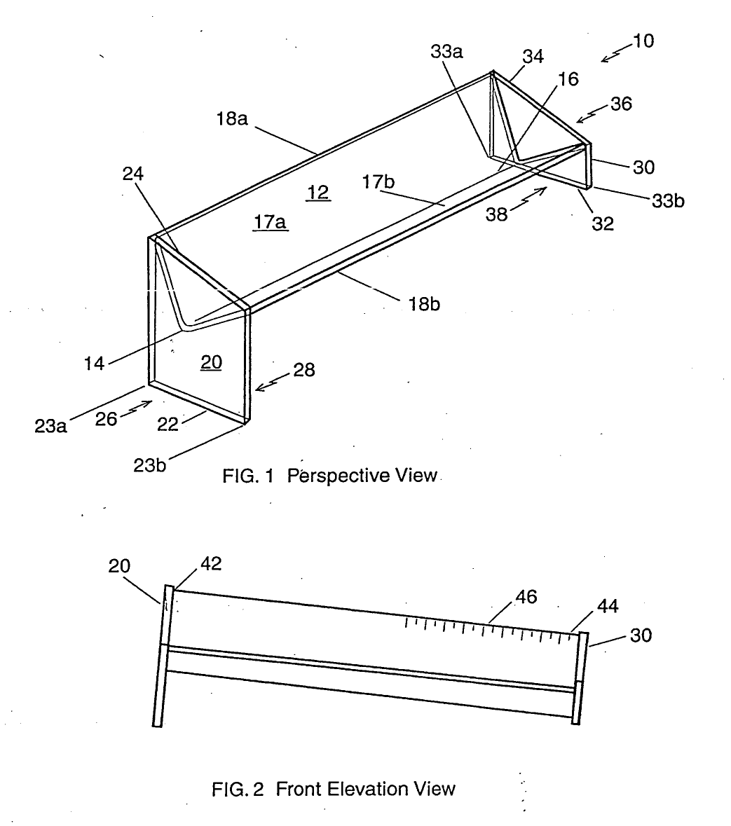

FIG. 1 shows the butter dish 10 in the preferred embodiment made of plastic as the butter dish 10 is intended to rest on a horizontal surface, such as a table (not shown). A plastic, metal, glass, or ceramic butter dish 10 can be easily cleaned in a dishwasher; however, plastic is chosen for the preferred embodiment as the most lightweight and durable material choice. The tray 12 is a generally planar, rectangular element, having a first end 42 (hereinafter referred to as the high end) and a second end 44 (hereinafter referred to as the low end) (best shown in FIG. 2) and angled along its length within a range of generally 90 to 120 degrees, but for the preferred embodiment, the longitudinal angle 14, or fold, measures approximately 100 degrees. From the longitudinal angle edge 16, which extends down the approximate centerline of the tray 12, the tray panels 17a and 17b extend approximately equidistantly to the longitudinal outer edges 18a and 18b, such that the longitudinal outer edges 18a and 18b are located higher than the longitudinal angle edge 16.

The tray 12 extends at an incline between the two endpieces 20 and 30, which in the preferred embodiment are roughly trapezoidal. The first endpiece 20, attached to the first end 42 of the tray 12, has a straight bottom edge 22, defined by two adjacent angles 23a and 23b measuring approximately ninety degrees each, and a top edge 24. Although it is not important to the invention that these endpieces be trapezoidal or even planar (e.g., the outer surfaces 26 and 36 could be designed with three-dimensional decorations), it is important that the inner surfaces 28 and 38 of the endpieces be generally planar so as to attach sufficiently to the tray 12 and also so as to provide an efficient stop for the stick of butter (not shown). The first endpiece 20 holds the high end 42 of the tray 12 such that the longitudinal outer edges 18a and 18b are located proximate the top edge 24.

The second endpiece 30 has a straight bottom edge 32, defined by two adjacent angles 33a and 33b measuring approximately ninety degrees each, and a top edge 34, and holds the low end 44 of the tray 12 such that the longitudinal angle edge 16 is located proximate the bottom edge 32. In this way, the tray 12 is inclined from the horizontal between the two endpieces 20 and 30 so that the stick of butter will rest in the tray against one of the endpieces.

Once a user has placed the butter dish 10 on a generally horizontal surface, the user simply places a stick of butter within the tray 12, and the butter stick will come to rest against the lower endpiece (e.g., second endpiece 30 in the illustration). When the user then uses a butter knife to cut a pat from the upper end of the butter stick, the lower endpiece will stop the butter stick from sliding longitudinally and will absorb any normal force from the user's knife. The angled design of the tray 12 will further help to contain the butter stick within the butter dish 10 by preventing lateral sliding. A measuring scale 46 (seen in FIG. 2) can be added to the tray 12, such scale 46 being used by the user for measuring the butter pats to be cut.

In FIG. 2, one can see how the tray 12 is inclined with respect to the horizontal. It is not necessary that the endpieces be different sizes (i.e., they could be identical), but for the preferred embodiment it has been chosen for the first endpiece 20 to simply be taller than the second endpiece 30. Nor is it necessary for the endpieces to be similarly shaped. It is necessary, however, for the second endpiece 30 to be large enough to provide a stop for the butter stick and absorb any normal force from the butter knife while the pat is being cut from the upper end. Also, for stability purposes, it is necessary for the two endpieces to have generally straight bottom edges that will rest on the horizontal surface.

1. A butter dish comprising:
a tray intended to accommodate a stick of butter, comprising a generally rectangular panel of longitudinally angled material defining a longitudinal angle edge and two longitudinal outer edges, the longitudinal outer edges being generally equidistant from the longitudinal angle edge, such tray having a first end and a second end, the ends being generally orthogonal to the edges;
a first endpiece having a generally straight bottom edge and a top edge and being generally orthogonally fixedly attached to the first end of the tray such that the bottom edge of the endpiece is positioned proximate the longitudinal angle edge of the tray but spaced outwardly therefrom and top edge of the endpiece is positioned proximate the longitudinal outer edges of the tray;
a second endpiece having a generally straight bottom edge and a top edge and being generally orthogonally fixedly attached to the second end of the tray such that the top edge of the endpiece is positioned proximate the longitudinal outer edges of the tray but spaced outwardly therefrom and the bottom edge of the endpiece is positioned proximate the longitudinal angle edge of the tray.

2. The butter dish of claim 1 wherein the longitudinal angle of the tray measures approximately one hundred degrees, and the longitudinal outer edges of the tray are generally equidistant from the longitudinal angle edge.

3. The butter dish of claim 1 wherein the endpieces are generally planar, generally parallel, and generally trapezoidal in shape, the top edge of the first endpiece being generally straight and the top edge of the second endpiece being generally straight.

4. The butter dish of claim 3 wherein the longitudinal outer edges at the first end of the tray are located proximate the top edge of the first endpiece, and the longitudinal angle edge at the second end of the tray is located proximate the bottom edge of the second endpiece.

5. The butter dish of claim 3 wherein the longitudinal outer edges at the first end of the tray are located coincident with the top edge of the first endpiece, and the longitudinal angle edge at the second end of the tray is located coincident with the bottom edge of the second endpiece.

6. The butter dish of claim 1 wherein the tray includes a measuring scale thereon with which the user can measure the butter to be cut.

7. A butter dish comprising:
two substantially planar, substantially parallel endpieces, such endpieces being spaced apart so that each endpiece has an inner surface facing toward the opposite endpiece, each endpiece defining a bottom generally straight edge between two adjacent angles, each angle measuring approximately ninety degrees; and
a tray fixed therebetween, such tray inclining from one endpiece toward the opposing endpiece, such tray comprising a single sheet of generally rectangular material angled along its length so as to define a longitudinal angle edge also inclining from one endpiece toward the opposing endpiece and two longitudinal outer edges, said longitudinal outer edges being approximately equidistant from the longitudinal angle edge, and attached to the inner surfaces of the endpieces such that the two longitudinal outer edges incline from one endpiece toward the opposing endpiece and are positioned above the longitudinal angle edge and the longitudinal angle edge is positioned proximate the bottom edges of the endpieces.

8. The butter dish of claim 7 wherein the endpieces further define outer surfaces and are positioned such that each outer surface faces away from the opposite endpiece.

9. The butter dish of claim 8 wherein the longitudinal angle of the tray measures approximately one hundred degrees, and the longitudinal outer edges are generally equidistant from the longitudinal angle edge.

10. The butter dish of claim 9 wherein the endpieces are generally planar and generally trapezoidal in shape.

11. The butter dish of claim 10 wherein the longitudinal outer edges at one end of the tray are located proximate the top edge of the adjacent endpiece and the longitudinal angle edge at the other end of the tray is located proximate the bottom edge of the adjacent endpiece.

12. The butter dish of claim 10 wherein the longitudinal outer edges at one end of the tray are located coincidentally with the top edge of the adjacent endpiece and the longitudinal angle edge at the other end of the tray is located coincidentally with the bottom edge of the adjacent endpiece.

13. The butter dish of claim 7 wherein the tray comprises a measuring scale for measuring the butter to be cut.

14. A butter dish for holding a conventional stick of butter comprising:
a generally horizontal tray having a first end and a second end, said tray defining a longitudinal fold extending down the approximate centerline of the tray from the first end to the second end;
a first endpiece having a generally straight bottom edge attached generally orthogonally to the first end and a second endpiece having a generally straight bottom edge attached generally orthogonally to the second end such that the first end of the tray is higher than the second end when the bottom edges of the endpieces rest on a horizontal surface.

15. The butter dish of claim 14 wherein the tray further comprises a measuring scale thereon.
